(19) United States
(12) Patent Application Publication
(10) Pub. No.: US 2024/0262495 A1
(43) Pub. Date: Aug. 8, 2024

(54) A DRIVING DEVICE FOR AN AIRCRAFT AND AN AIRCRAFT

(71) Applicant: WESTLAKE UNIVERSITY, Hangzhou, Zhejiang (CN)

(72) Inventors: Wei LI, Hangzhou, Zhejiang (CN); Bing LUO, Hangzhou, Zhejiang (CN); Weicheng CUI, Hangzhou, Zhejiang (CN)

(21) Appl. No.: 18/562,851

(22) PCT Filed: May 21, 2021
(86) PCT No.: PCT/CN2021/095053

§ 371 Date: Nov. 21, 2023

(51) Int. Cl. B64C 33/02

(52) U.S. Cl. CPC B64C 33/02

(57) ABSTRACT

The embodiments of the disclosure provide a driving device for an aircraft and an aircraft, and the driving device includes a first energy storage motor device, a second energy storage motor device, a third energy storage motor device, a fourth energy storage motor device and a crankshaft, wherein a first end of the crankshaft is fixedly connected to the first energy storage motor device, and a middle portion of the crankshaft is connected to the second energy storage motor device, the second energy storage motor device is connected by a supporting portion to the third energy storage motor device, and the fourth energy storage motor device is provided at a output end of the third energy storage motor device, power output directions of the first energy storage motor device, the second energy storage motor device, the third energy storage motor and the fourth energy storage motor device are different from each other. The embodiment of the disclosure, by providing multiple energy storage motor devices, can make the wings of the aircraft achieve different individual movements, and the combination of the multiple individual movements can form complex spatial movements, thereby making the sailing modes of the aircraft more diverse, and making the bionic effect better.

### CROSS REFERENCE TO RELATED APPLICATION

This application is based on and claims the priority of CN Application No. 202110556731.4, filed on May 21, 2021, which is incorporated herein by reference in its entirety.

### TECHNICAL FIELD

The embodiments of the disclosure relate to the technical field of aircraft driving, more specifically, to a driving device for an aircraft and an aircraft.

### BACKGROUND

In the driving control of the existing aircraft, it is often realized by a single motor to drive the connecting rod, which cannot make the wing of the aircraft realize complex motion.

### SUMMARY

In order to improve the above-mentioned problems, the purpose of the embodiments of the disclosure is to provide a driving device for an aircraft and an aircraft to solve the problem existing in the present technology that it cannot make the wing of the aircraft achieve complex motion.

In order to solve the above-mentioned problems, the embodiments of the disclosure adopt the technical solution as follows:

The disclosure provides a driving device for an aircraft, which comprises a first energy storage motor device, a second energy storage motor device, a third energy storage motor device, a fourth energy storage motor device and a crankshaft, wherein a first end of the crankshaft is fixedly connected to the first energy storage motor device, and a middle portion of the crankshaft is connected to the second energy storage motor device, the second energy storage motor device is connected by a supporting portion to the third energy storage motor device, and the fourth energy storage motor device is provided at a output end of the third energy storage motor device, power output directions of the first energy storage motor device, the second energy storage motor device, the third energy storage motor and the fourth energy storage motor device are different from each other.

In some embodiments, the supporting portion comprises a base, a circle-shaped portion and a fixing frame, and a fixing column is provided on the base, and the circle-shaped portion is sleeved on the fixing column, and the fixing column is a hollow structure, wherein the fixing frame is provided at a output end of the second energy storage motor device, wherein the base comprises a U-shaped portion and a ring-shaped portion, and the circle-shaped portion and the ring-shaped portion are provided in parallel to each other, the U-shaped portion is connected to the output end of the second energy storage motor device, and the circle-shaped portion and the ring-shaped portion are respectively sleeved at different positions on the third energy storage motor device.

In some embodiments, any one of the first energy storage motor device, the second energy storage motor device, the third energy storage motor device and the fourth energy storage motor device comprises a motor assembly and a coupling, and the motor assembly includes a motor, and a output shaft of the motor is provided on a output side of the motor assembly, wherein a sliding chute is provided on an end plane of the motor assembly and a spring is provided in the sliding chute, one end of the coupling is sleeved on the output shaft and can rotate with the output shaft, and the other end of the coupling moves in the sliding chute and can compress the spring based on the rotation of the output shaft.

The disclosure further provides an aircraft comprising a frame and at least one wing, further comprises the driving device according to any one of the above-mentioned technical solutions.

In some embodiments, a connecting portion is provided at a second end of the crankshaft, and the first energy storage motor device and the connecting portion are respectively connected to the frame.

In some embodiments, a first connection component and a second connection component are respectively provided on the frame, and the first connection component is connected to the first energy storage motor device, and the second connection component is connected to the connecting portion.

In some embodiments, the wing includes a wing supporting rod and a wing tip supporting rod, and a first end of the wing supporting rod is movably connected to the driving device, and a second end of the wing supporting rod is movably connected to the wing tip supporting rod.

In some embodiments, a rotating device is provided between the wing supporting rod and the wing tip supporting rod.

In some embodiments, the rotating device comprises a base portion and a joint portion, and the base portion is fixedly provided on the second end of the wing supporting rod, the base portion includes two upright posts provided in parallel with each other, and a U-shaped supporting table is provided between the upright posts and a rotating shaft is provided on the supporting table, the upright posts are connected to a middle portion of the rotating shaft, and two long sides of the joint portion which is provided in a U shape are rotatably connected to the rotating shaft.

In some embodiments, the driving device and the rotating device are connected by a traction device.

In some embodiments, the third energy storage motor device is movably connected to the wing supporting rod.

In some embodiments, the first end of the wing supporting rod is sleeved on the coupling of the output end of the third energy storage motor device, and the wing supporting rod and the supporting portion are connected by a first fixing component.

In some embodiments, a main body wing plate and a wing tip wing plate are respectively laid on the wing supporting rod and the wing tip supporting rod.

In some embodiments, the fourth energy storage motor device is provided on the wing supporting rod.

In some embodiments, one end of the fourth energy storage motor device is fixedly connected to the coupling of the output end of the third energy storage motor device, and the other end is connected to the wing supporting rod by a second fixing component.

In some embodiments, a rotation control portion is provided on the coupling of an output end of the fourth energy storage motor device, and the rotation control portion is connected to the rotating device by the traction device.

In the embodiments of the disclosure, the moving joints of the wing of the aircraft are compact in structure, and are centrally provided on the side of the frame of the aircraft, reducing the mass of the moving portions of the wings and the rotary inertia of the wings, so that the movement of the wings is more flexible; the energy storage braking structure design of the energy storage motor device can make the motor to achieve rapid reverse rotation at the limit of the stroke of reciprocating rotation to meet the requirements of high frequency reciprocating motion, and save energy, so as to meet the requirements of high frequency swing of the wing. Therefore, the beneficial effect of the embodiments of the disclosure lies in that the embodiments of the disclosure can make the wings of the aircraft realize different individual actions by providing a plurality of energy storage motor devices and the combination of multiple individual actions can form complex spatial motions, thereby making the sailing modes of the aircraft more diverse and making the bionic effect better.

### BRIEF DESCRIPTION OF THE DRAWINGS

In order to illustrate the embodiments of the disclosure or the technical solutions in the current technology more clearly, drawings that need to be used in the description of the embodiments or the prior art are introduced as follows, obviously, the following drawings are only some of the embodiments recorded in this disclosure, and for those skilled in the art, other drawings can be obtained according to these drawings without any creative labor.

FIG. 1 is a schematic structural diagram of an aircraft according to an embodiment of the disclosure;

FIG. 2 is a schematic connection diagram of the connection between a frame and a wing in an aircraft according to an embodiment of the disclosure;

FIG. 3 is a schematic connection diagram of the connection between a frame and a wing in an aircraft according to an embodiment of the disclosure;

FIG. 4 is a schematic structural diagram of a driving device in an aircraft according to an embodiment of the disclosure;

FIG. 5 is a schematic structural diagram of a frame in an aircraft according to an embodiment of the disclosure;

FIG. 6 is a schematic structural diagram of a crankshaft in a driving device according to an embodiment of the disclosure;

FIG. 7 is a schematic connection diagram of a driving device according to an embodiment of the disclosure;

FIG. 8 is a schematic connection diagram of a driving device according to the embodiment of the disclosure;

FIG. 9 is a schematic connection diagram of a driving device according to an embodiment of the disclosure;

FIG. 10 is a schematic connection diagram of a driving device according to the embodiment of the disclosure;

FIG. 11 is a schematic connection diagram of a driving device according to an embodiment of the disclosure;

FIG. 12 is a schematic structural diagram of an energy storage motor device according to an embodiment of the disclosure;

FIG. 13 is an exploded schematic diagram of an energy storage motor device according to an embodiment of the disclosure;

FIG. 14 is a side view of an energy storage motor device according to an embodiment of the disclosure;

FIG. 15 is a schematic diagram of a front cover in an energy storage motor device according to an embodiment of the disclosure;

FIG. 16 is a schematic diagram of a front cover in an energy storage motor device according to an embodiment of the disclosure;

FIG. 17 is a schematic diagram of a rear cover in an energy storage motor device according to an embodiment of the disclosure;

FIG. 18 is a schematic diagram of a rear cover in an energy storage motor device according to an embodiment of the disclosure;

FIG. 19 is a schematic structural diagram of a coupling in an energy storage motor device according to an embodiment of the disclosure;

FIG. 20 is a side view of a coupling in an energy storage motor device according to an embodiment of the disclosure.

### DRAWING MARKS

10—motor assembly; 1—front cover; 11—first fixing hole; 12—sliding chute; 13—first hole; 14—spring; 2—coupling; 21—socket portion; 22—lever portion; 23—second hole; 24—dial; 25—first projection portion; 26—second projection portion; 27—third hole; 3—output shaft; 5—rear cover; 51—second fixing hole; 52—annular portion; 53—protruding portion; 54—wire hole; 6—motor; 100—frame; 110—first wing; 111—wing supporting rod; 112—main body wing plate; 113—wing tip wing plate; 120—second wing; 130—dorsal fin; 140—caudal fin; 150—platform; 160—first connection component; 170—second connection component; 200—driving unit; 210—first energy storage motor device; 220—second energy storage motor device; 230—third energy storage motor device; 240—fourth energy storage motor device; 241—second fixing component; 242—rotation control portion; 250—crankshaft; 270—supporting portion; 271—base; 2711—U-shaped portion; 2712—ring-shaped portion; 272—circle-shaped portion; 273—fixing column; 274—rod portion; 275—first fixing component; 276—fixing frame; 300—rotating device; 310—base portion; 311—upright post; 312—supporting table; 313—rotating shaft; 320—joint portion; 400—traction device.

### DETAILED DESCRIPTION

Various programs and features of the disclosure are described herein with reference to the drawings.

It should be understood that various modifications may be made to the embodiments of the application herein. Therefore, the above description should merely be regarded as exemplifications of embodiments rather than limiting. Those skilled in the art will envision other modifications within the scope and spirit of this present disclosure.

The drawings, which are incorporated in and constitute a part of this specification, illustrate embodiments of the disclosure, together with the general description of the disclosure given above and the detailed description of the embodiments given below, and serve to explain the principles of the disclosure.

These and other features of the disclosure will become apparent from the following description of preferred forms of embodiments defined as a non-limiting example with reference to the drawings.

It is also to be understood that although the disclosure has been described with reference to some specific examples, those skilled in the art will be able to realize many other equivalent forms of the disclosure with certainty, which have the features as claimed in the claims and therefore lie within the scope of protection defined thereby.

The above and other aspects, features and advantages of the disclosure will become more apparent in view of the following detailed description When combined with the drawings.

Specific embodiments of the disclosure are hereinafter described with reference to the drawings; however, it is to be understood that the claimed embodiments are merely examples of the disclosure, which may be embodied in various ways. Well-known and/or repeated functions and constructions have not been described in detail to avoid obscuring the disclosure with unnecessary or redundant detail. Therefore, specific structural and functional details claimed herein are not intended to limit, but merely serve as a basis for the claims and a representative basis for teaching those skilled in the art to variously employ the present invention in substantially any suitable detailed structure.

This specification may use the phrases “in one embodiment”, “in another embodiment”, “in yet another embodiment”, or “in other embodiments”, which may all refer to one or more of the same or different embodiments according to the disclosure.

An embodiment of the disclosure provides a multi-degrees-of-freedom driving device for an aircraft, which is provided in, for example, a fish-shaped bionic aircraft, and the shape of the aircraft can also be selected from other shapes that are favorable for navigating in water; a wing is provided at least one side surface of the aircraft, and the sailing of the aircraft in water is realized by the movement of the wing.

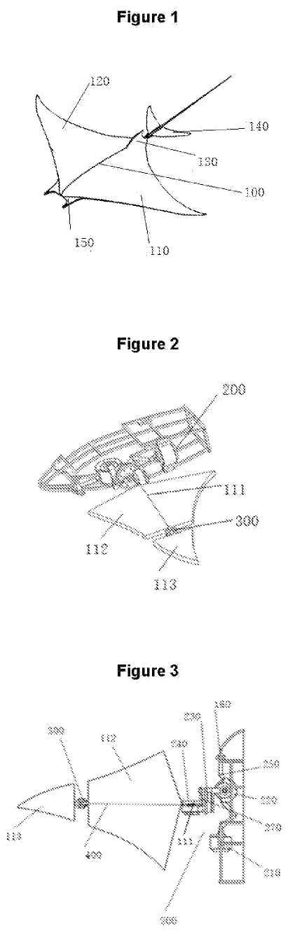

As shown in FIG. 1, FIG. 1 shows an embodiment of the structure of an aircraft and the overall shape of the aircraft is fish-shaped, wherein the aircraft includes a frame 100, and a first wing 110 (located on the left side of the frame 100, or referred to as a left wing) and a second wing 120 (located on the right side of the frame 100, or referred to as a right wing) are respectively provided on two sides of the frame 100, and the first wing 110 and the second wing 120 may be provided symmetrically to each other; further, a dorsal fin 130 and a caudal fin 140 are provided on the tail of the frame 100, and the posture and direction etc., involving sailing, of the aircraft are controlled by the dorsal fin 130 and the caudal fin 140, enabling the aircraft to simulate for example fish to the greatest extent to achieve the function of sailing in the water. Of course, it is necessary to obtain its relevant parameters during the navigation process in order to control the navigation of the aircraft in real time and for this reason, various types of sensors for monitoring the parameters required for navigation are provided at the head of the frame 100, and further, a fixed platform 150 may be provided on the head of the frame 100, and the sensors are provided on the platform 150.

FIG. 2 shows the connection relationship between the frame 100 and the wing in the aircraft, wherein the wing here is the first wing 110 located on the left side of the frame 100 is taken as an example, but this is not intended to limit the protection scope of the disclosure. The first wing 110 is movably connected to the side of the frame 100, specifically, a driving unit 200 is provided on the frame 100, and the frame 100 is movably connected by the drive unit 200 to the first wing 110, so that the first wing 110 can be driven by the driving unit 200 to realize various movements. Another driving unit 200 and the second wing 120 movably connected to the driving unit 200 are provided on one side of the frame 100, so as to realize different control of the two wings.

In this way, the driving unit 200 disposed on one side or both sides of the frame 100 drives the first wing 110 and/or the second wing 120 on the side of the frame 100, so that the wing(s) can realize a variety of basic motions, such as at least four basic motions: up and down swing, back and forth swing, pitch motion and spanwise bending of the wing etc., and the first wing 110 and/or the second wing 120 located on different sides can be independently controlled from each other, further, complex motion combinations can be realized by the different wings, that is, the configuration of the two wings can make the movement of the aircraft more various, so as to achieve excellent movement performance of the aircraft. In addition, the driving unit 200 is compactly connected to the wings, and they are centrally arranged on the side of the frame 100 of the aircraft. The structure of motion joints of the wings of the aircraft is compact and centrally provided on the side of the frame 100 of the aircraft, reducing the mass of the moving portion of the wings and the rotary inertia of the wings, thereby making the movement of the wings more flexible.

Continuing to refer to FIG. 2 and FIG. 3, the first wing 110 includes a wing supporting rod 111 and a wing tip supporting rod (not shown), and a main body wing plate 112 and a wing tip wing plate 113 are respectively laid on the wing supporting rod 111 and the wing tip supporting rod, wherein a first end of the wing supporting rod 11I is movably connected with the driving unit 200 on the frame 100, and a second end of the wing supporting rod 111 is movably connected to the wing tip supporting rod, so that the main body wing plate 112 and the wing tip wing plate 113 can be driven to move by the driving unit 200, thereby driving the movement of the main body wing plate 112 and the wing tip wing plate 113.

Specifically, in order to facilitate the control of the movement of the wing tip wing plate 113, a rotating device 300 is provided between the wing supporting rod 111 and the wing tip supporting rod, and the second end of the wing support rod 111 is connected by the rotating device 300 to the wing tip supporting rod, so that the rotating device 300 can drive the wing tip wing plate 113 to rotate and other move relative to the main body wing plate 112, and the rotating device 300 here serves as a wing tip rotation joint; further, in order to ensure the motion control of the wing tip wing plate 113, the driving unit 200 and the rotating device 300 are also connected by a traction device 400, and the traction device 400 here can be, for example, using a rope or link for driving wing tip to rotate joint.

In this way, in the aircraft involved in the embodiments of the disclosure, the order in which the components are connected in sequence between the frame 100 and the first wing 110 is that the driving unit 200 and the wing supporting rod 111 is connected, the wing supporting rod 111 is connected with the rotating device 300, the rotating device 300 is connected with the wing tip supporting rod, and the main body wing plate 112 is fixedly laid on the wing supporting rod 111, the wing tip wing plate 113 is fixedly laid on the wing tip supporting rod.

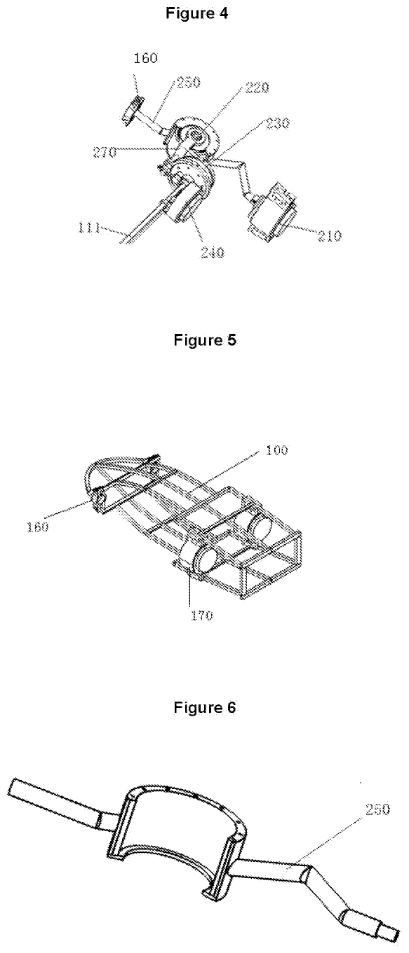

FIG. 3 shows the connection mode of the driving unit 200 with the wing and the frame 100, FIG. 4 shows the three-dimensional structure of the driving unit 200 in the aircraft, and FIG. 5 shows the three-dimensional structure of the frame 100, and according to FIG. 3 and in conjunction with FIGS. 4 and 5, the driving unit 200 includes a first energy storage motor device 210, a second energy storage motor device 220, and a third energy storage motor device 230, the fourth energy storage motor device 240 and a crankshaft 250, wherein each energy storage motor device here includes a driving device, and the driving device here can adopt a motor assembly, the motor assembly includes a motor for outputting power and a gland, and the gland is used to encapsulate and accommodate the motor, and a coupling is provided on the output shaft of the motor assembly; the crankshaft 250 is fixedly connected to the frame 100, wherein the structure of the crankshaft 250 is shown in FIG. 6, a first end of the crankshaft 250 is fixedly connected with the first energy storage motor device 210, and a second end of the crankshaft 250 is provided with a first connection component 160, so that the first energy storage motor device 210 can drive the rotation of the crankshaft 250; the middle of the crankshaft 250 is connected to the second energy storage motor device 220, so that the second energy storage motor device 220 is provided on the crankshaft 250, and the second energy storage motor device 220 is connected by a supporting portion 270 to the third energy storage motor device 230, the third energy storage motor device 230 is movably connected to the wing supporting rod 110, and the fourth energy storage motor device 240 is provided on the wing supporting rod 110, wherein power output directions of the first energy storage motor device 210, the second energy storage motor device 220, the third energy storage motor device 230 and the fourth energy storage motor device 240 are different from each other, so that the first wing 110 can move in different directions by the determination of different energy storage motor devices. Preferably, the power output directions of the first energy storage motor device 210, the second energy storage motor device 220 and the third energy storage motor device 230 are perpendicular to each other.

It should be noted here that the first energy storage motor device 210, the second energy storage motor device 220, the third energy storage motor device 230 and the fourth energy storage motor device 240 have the same structure and function, and the first energy storage motor device 210 is used as an example to introduce its specific structure in this embodiment of the disclosure. The energy storage motor device here can be widely used in the case of motor reciprocating rotation, especially for the motion control of a bionic aircraft, for example, in the movement of the bionic aircraft, the up and down swing of its wings is driven by reciprocating rotation of a driving device such as a motor, and in this process, the output end of the motor realizes the reciprocating rotation in two directions by the forward or reverse rotation of the motor, and the output end moves in one direction and needs to brake and slow down when a direction change is required. The embodiment of the disclosure can realize the braking effect when the motor performs direction conversion during the movement of the output end, and can realize the storage and release of kinetic energy.

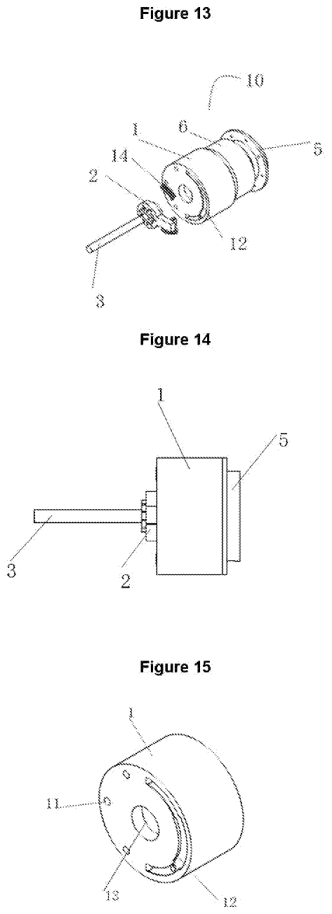

As shown in FIG. 12-FIG. 15, FIG. 12-FIG. 15 show the energy storage motor device in this embodiment, wherein FIG. 12 shows a three-dimensional schematic diagram of the energy storage motor device, and FIG. 13 shows an exploded view of the energy storage motor device, FIG. 14 shows a side view of the energy storage motor device, specifically, the energy storage motor device includes a driving device, wherein the driving device here can use a motor assembly 10 including a motor 6 for outputting power and a gland. The gland is used to encapsulate and accommodate the motor 6 and the motor 6 can be stably fixed in the gland and can rotate in different directions such as clockwise or counterclockwise and so on to output kinetic energy; in order to provide the fixing of the motor 6 in the grand, specifically, the grand includes a front cover 1 and a rear cover 5, and the shape of the front cover 1 and the rear cover 5 are not specifically limited, as long as the front cover 1 and the rear cover 5 are closed to each other and the motor 6 can be stably fixed therein; preferably, when the motor 6 is packaged by the grand 5, the front cover 1 is located on the output side of the motor assembly, so that the output portion of the motor 6 can easily extend from the grand, that is, the kinetic energy of the motor 6 in the motor assembly can be output in the direction of the front cover 1. Especially when the aircraft is used for underwater navigation, the grand can make the motor 6 sealing under water.

In a specific embodiment, the front cover 1 may be acylinder shape with one side closed and the other side open, and the cylinder shape is matched with the housing shape of the motor 6 so as to make the motor 6 fixedly accommodated in the front cover 1, and the rear cover 5 can cover the opening, so as to cover the front cover 1 to form the gland to encapsulate the motor 6.

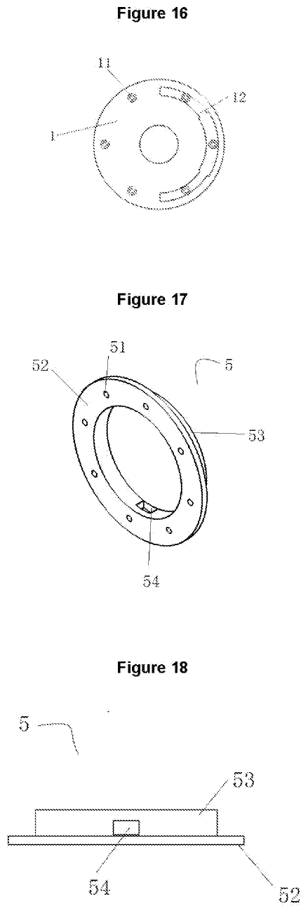

Further, FIG. 15 shows a stereogram of the front cover 1, FIG. 16 shows a front view of the front cover 1, FIG. 17 shows a stereogram view of the rear cover 5, and FIG. 18 shows the side view of the back cover 5. Referring to FIG. 12-FIG. 15 and in conjunction with FIG. 15-FIG. 18, in order to realize the encapsulation effect of the gland to the motor 6, a first fixing hole 11 is provided on an end plane of the front cover 1, a second fixing hole 51 is provided on the end plane of the rear cover 5, and the gland is used to encapsulate after the motor 6 is fixed by the first fixing hole 11 and the second fixing hole 51 cooperating with, for example, a screw therein.

Further, since the rear cover 5 is closed on the front cover 1 to form the gland to encapsulate the motor 6, the rear cover 5 includes an annular portion 52, and the annular portion 52 is connected to an end plate of the cover 1, and the second fixing hole 51 can be provided on the annular portion 52; in addition, a protruding portion 53 is provided on the inner side of the annular portion 52 and away from the front cover 1. Preferably, the protruding portion 53 and the annular portion 52 can be provided perpendicular to each other. Considering that the kinetic energy of the motor assembly in the gland is output by the direction of the front cover 1, the power lines, control lines, etc. of the motor 6 are provided from the direction of the back cover 5. The power lines and control lines and others used by the motor 6 need to extend from the outside of the motor assembly into the motor assembly and be connected with the motor 6. For this purpose, a wire hole 54 is provided on the protruding part 53, and the wire hole 54 is used to allow the power cable and control wire used by the motor 6 to pass through and connect with the motor 6.

Further, as shown in FIG. 12-FIG. 15, the motor 6 as a driving device has an output shaft 3 by which the motor 6 outputs power, and the output shaft 3 is installed on the output side of the motor assembly, which passes through and extends out of the gland of the motor assembly 10, especially passes through the front cover 1 of the gland, for example, a through hole may be provided on the front cover 1 to facilitate the output shaft 3 passing through, wherein a coupling 2 is provided on the output side of the motor assembly, and the coupling 2 is associated with, for example, the movement of the wing. The coupling 2 is specifically located on the outside of the motor assembly, especially on the outside of the front cover 1, and the coupling 2 is fixedly sleeved on the output shaft 3, which can rotate with the rotation of the output shaft 3. Specifically, a first hole 13 is provided on the motor assembly, especially on the front cover 1, and a part of the coupling 2 passes through the first hole 13 to fix with the motor 6 in the motor assembly 10.

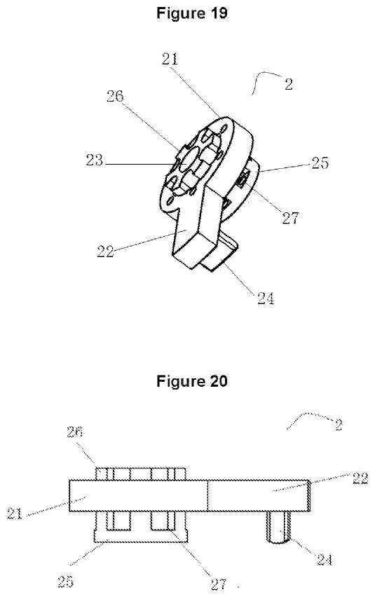

Further, as shown in FIG. 19 and FIG. 20, FIG. 19 shows a three-dimensional schematic of the coupling 2, and FIG. 20 shows a side view of the coupling 2, and the coupling 2 includes a socket portion 21 and a lever portion 22, wherein the socket portion 21 can be made in one piece with the lever portion 22, and the socket portion 21 is connected with the output shaft 3; in order to facilitate the connection with the output shaft 3, the socket part 21 can be a disc shape. Specifically, the socket part 21 is provided with a second hole 23 that is matched with the output shaft 3, and the output shaft 3 passes through the first hole 23 so as to allow the coupling 2 to be fixedly provided on the output shaft 3; further, the proximal end of the lever portion 22 is connected to the socket portion 21, and a dial 24 is provided on the distal end of the lever portion 22, and the dial 24 is provided on a first side of the socket portion 21 facing the front cover 1 and perpendicular to the lever portion 22; in this way, the socket portion 21 can be sleeved on the output shaft 3 and can rotate coaxially with the output shaft 3, so that when the socket portion 21 rotates with the output shaft 3, the socket portion 21 drives the dial 24 to rotate by the lever portion 22, so that the kinetic energy output by the motor assembly 10 will be transmitted to the lever portion 22.

Considering that the coupling 2 is provided on the outer side of the front cover 1, the dial 24 is provided on the first side of the lever portion 22 facing the front cover 1. Further, because the kinetic energy of the shaft 3 will be transmitted to the lever portion 22 along with the rotation of the coupling 2, in order to realize the storage and release of the kinetic energy, as shown in FIG. 1 and FIG. 2, a sliding chute 12 is provided on the outer side of the motor assembly 10, and the sliding chute 12 can especially be provided on the end plane of the front cover 1 of the gland. The sliding chute 12 is used to accommodate the dial 24, and the shape of the sliding chute 12 matches with the shape of the front cover 1 for matching the movement of the dial 24, so that the dial 24 can be inserted into the sliding chute 12, and move in the sliding chute 12 with the rotating of the dial 24, and accordingly, the shape of the dial 24 matches the cross-sectional shape of the sliding chute 12.

Further, the length of the sliding chute 12 can be determined according to the movement range of the dial 24, that is, the dial 24 moves within the range of the sliding chute 12, and the movement range of the dial 24 is determined based on the swing range of the wing, and it is determined based on the range of forward or reverse rotation of the motor 6. Here, correspondingly, the sliding chute 12 has a certain range, and its two ends are the two end points of the movement range of the dial 24; since the dial 24 moves as rotation of the output shaft 3 of the motor assembly 10, and its movement trajectory is arc-shaped. Therefore, the shape of the sliding chute 12 here can be provided to be for example arc-shaped, so that the dial 24 can moves following the arc-shaped sliding chute 12 movement.

Further, since the dial 24 moves within a certain range in the sliding chute 12, a spring is provided in the sliding chute 12 so that the paddle 24 can compress the spring when moving in the sliding chute 12 to brake by the spring, and the kinetic energy is stored by the compression of the spring. In this way, the kinetic energy is stored during the stroke of the dial 24 to compress the spring, and in the process of the spring is released, the elastic potential energy is converted into the kinetic energy for the rotation of the motor 6. For example, a gap can be provided in the middle portion of the sliding chute 12 to facilitate the installation of the spring. Specifically, considering the forward rotation and reverse rotation of the motor 6, the output shaft 3 can be rotated in two directions, and finally the dial 24 can rotate in two directions, such as clockwise and counterclockwise. In this way, the two ends of the sliding chute 12 are respectively the end point of the movement of the dial 24 when the motor 6 rotates forwardly or reversely. If the dial 24 continues to move, it will contact and damage the motor 6, therefore, the dial 24 needs braking and kinetic energy storage when moving to two ends; for this purpose, the springs 14 are respectively fixedly provided at these two ends, and the dial 24 can move back and forth in the sliding chute 12 during the forward or reverse rotation of the motor 6 and can respectively compress the springs 14 located at the two ends of the sliding chute 12, so as to compress the springs 14 located at the two ends by the dial 24 during the rotation of the motor 6 in both directions to realize braking and kinetic energy storage respectively, and the kinetic energy is stored during the dial 24 compress the springs 14, and the elastic potential energy is converted into the kinetic energy of the rotation of the motor 6 during the process of releasing the spring 14. And the motor 6 can be braked at the end of the reciprocating rotation, that is, at the limit position where the spring 14 is compressed, and quickly reversely rotate, so as to meet the requirements of high-frequency reciprocating rotation of the motor and save energy. Wherein, the length of the spring 14 in the natural state, that is, the compression stroke of the spring 14 can be determined according to needs. If the length of the sliding chute 12 is greater than the sum of the natural lengths of the springs 14 at the two ends of the sliding chute 12, it means that there is an idle stroke, i.e., the springs 14 is not compressed during the idle stroke.

Further, as shown in FIG. 19 and FIG. 20, in order to facilitate the installation of the coupling 2 on the output shaft 3, a first side of the socket portion 21 facing the front cover 1 is provided with a first projection portion 25, a second projection portion 26 is provided on asecond side away from the front cover 1 of the socket portion 21, and the first projection portion 25 and the second projection portion 26 are used to strengthen the connection strength between the coupling 2 and the output shaft 3. The shape of the first projection portion 25 is matched with the first hole 13 and passes through the first hole 13. At least one third hole 27 is provided on the first projection portion 25, and the first projection portion 25 is connected to the housing of the motor 6 of the motor assembly 10 by the third hole 27. In addition, a key structure may be provided between the second projection portion 26 and the output shaft 3 to ensure that the coupling 2 and the output shaft 3 rotate coaxially.

By adopting the energy storage motor device of the embodiment of the disclosure, the work is realized in the following manner:

Driven by the motor 6 in the motor assembly, the output shaft 3 is driven to rotate by the coupling 2; the coupling 2 transmits kinetic energy to the dial 24 by the lever portion 22, wherein the radius of curvature of the movement of the dial 24 is consistent with the radius of curvature of the sliding chute 12, so that the dial 24 can slide smoothly in the sliding chute 12; wherein, a gap is set in the middle portion of the sliding chute, the diameter of which is slightly larger than the diameter of the spring 14, so as to ensure that the spring 14 is easy to install and can be pushed to the end of the sliding chute 12 for fixing in the axial direction, thus ensuring that the spring 14 always compresses and recovers in the sliding chute 12 after being in contact with the dial 24, and there will be no circumferential movement or falling out of the chute 12.

The embodiment of the disclosure is used in conjunction with the control of the driving device, for example, it can be used in the operation of the bionic aircraft, and the work flow is as follows: during the idle stroke process, the motor 6 is powered on and driven to drive the external load to work. When the dial 24 is about to contact the spring 14 by rotating, the motor 6 can be powered off and continue to move by relying on the inertia of the load, so that the idle 24 compresses the spring 14 and converts most of the kinetic energy of the load into the elastic potential energy of the spring 14 to be stored, and braking is realized. When the spring 14 is compressed to the shortest point, the direction of the motor current, the elastic potential energy of the spring 14 is also released, so that in the case of the rotor in the motor 6 is under the same load, it has a larger reversed torque than the pure current, and the direct reflection is that the reverse acceleration is faster. It is more advantageous in the reciprocating motion of most bionic machines. The energy storage braking structure design of the motor here can make the motor quickly reversely rotate at the limit of the reciprocating rotation stroke, meet the requirements of high-frequency reciprocating motion, and save energy, so as to meet the requirements of high-frequency swing at the output end.

Further, as shown in FIG. 5, in order to make a fixed connection between the crankshaft 250 and the frame 100, the first energy storage motor device 210 provided at the first end of the crankshaft 250 and the first connection component 160 at the second end of the crankshaft 250 are respectively connected to the frame 100, wherein, in order to facilitate the connection of the first energy storage motor device 210 to the frame 100, a first connection component 160 and a second connection component 170 are respectively provided on the frame 100, wherein the second connection component 170 is connected to the gland of the first energy storage motor device 210, and the first energy storage motor device 210 and the crankshaft 250 are connected by a crankshaft coupling; the second connection component 170 is connected to the frame 100, so that the crankshaft 250 is connected to the frame 100, Therefore, the driving unit 200 can be fixed on the frame 100, and the first connection component 160 here can be a rolling bearing support, of course, a motor, so that although the degree of freedom has not changed, the degree of driving force can be increased. In addition, in order to connect the middle of the crankshaft 250 to the second energy storage motor device 220, as shown in FIG. 6, the crankshaft 250 and the gland of the second energy storage motor device 220 may be integrally made.

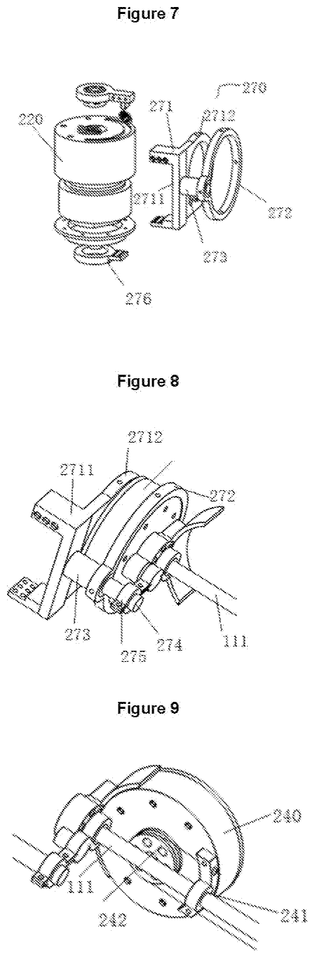

As described above, the second energy storage motor device 220 and the third energy storage motor device 230 are connected by the supporting portion 270. As shown in FIG. 7 and FIG. 8, the supporting portion 270 includes a base 271, a circle-shaped portion 272 and a fixing frame 276, a fixing column 273 is provided on the base 271, and the circle-shaped portion 272 is provided on the base 271 by being sleeved on the fixing column 273, and the fixing column 273 is a hollow structure and a rod portion 274 can be inserted therein, wherein the base 271 includes a U-shaped portion 2711 and an ring-shaped portion 2712, and the circle-shaped portion 272 and the ring-shaped portion 2712 are provided in parallel to each other, wherein the second energy storage motor device 220 is clamped to the U-shaped portion 2711. Specifically, the two long sides of the U-shaped portion 2711 are respectively connected to the coupling at the output end of the second energy storage motor device 220 and the fixing frame 276, so that the supporting portion 270 can rotate with the rotation of the coupling of the second energy storage motor device 220, and the circle-shaped portion 272 and the ring-shaped portion 2712 are respectively sleeved at different positions on the gland of the third energy storage motor device 230, so that the third energy storage motor device 230 can be provided on the supporting portion 270, and is provided on the second energy storage motor device 220 by the supporting portion 270, so that the third energy storage motor device 230 can be provided on the crankshaft 250, so that when the second energy storage motor device 220 rotates, the third energy storage motor device 230 is driven to rotate by the supporting portion 270.

In this way, during installation, the motor in the second energy storage motor device 220 is fixedly connected to the front cover of the gland, the rear cover of the gland is fixedly connected to the front cover, and the fixing frame 276 is connected to the shaft on the rear cover of the gland in the second energy storage motor device 220, wherein the springs in the second energy storage motor device 220 are respectively fixedly connected to the sliding chute in the end plane of the front cover, and the coupling and the dial are fixedly connected to the output end of the second energy storage motor device, and the dial is provided in the sliding chute of the front cover, and both ends of the supporting portion 270 are respectively fixedly connected to the coupling and dial of the second energy storage motor device 220 and the fixing frame 276. The third energy storage motor device 230 is fixedly connected to the supporting portion 270, and the rod portion 274 of the supporting portion 270 is connected to the fixing column 273, and the coupling of the third energy storage motor device 230 is fixedly connected to the output shaft of the third energy storage motor device 270, and the wing supporting rod 111 is fixedly connected to the coupling of the third energy storage motor device 230.

Further, as shown in FIG. 8, the first end of the wing supporting rod 111 is sleeved on the coupling of the output end of the third energy storage motor device 230, and the wing supporting rod 111 is connected to the fixing column 273 on the supporting portion 270 or the rod portion 274 inserted into the fixing column 273 by the first fixing component 275, so that the wing supporting rod 111 is fixedly provided relative to the support part 270. In this way, the third energy storage motor device 230 can drive the wing supporting rod 111 to rotate.

Further, as shown in FIG. 9, the fourth energy storage motor device 240 is disposed on the wing supporting rod 111, and one end of the fourth energy storage motor device 240 is fixedly connected to the coupling at the output end of the third energy storage motor device 230, and the other end is connected by the second fixing component 241 to the wing supporting rod 111, so that the fourth energy storage motor device 240 can rotate with the third energy storage motor device 230 rotating. A rotation control portion 242 is provided on the coupling at the output end of the fourth energy storage motor device 240, and the rotation control portion 242 is connected by the traction device 400 to the rotating device 300 to control the movement of the wingtip supporting rod.

In this way, during installation, the side wall of the fourth energy storage motor device 240 is tightly fixedly connected to the arc portion of the coupling of the third energy storage motor device 230, and the second fixing component 241 is fixedly connected to the wing supporting rod 111, the end plane of the output shaft of the fourth energy storage motor device 240 is fixedly connected with the second fixing component 241, and the second fixing component 241 is connected by the rolling bearing to the wing supporting rod 111. The rotation control portion 242 is fixedly connected to the output shaft of the fourth energy storage motor device 240, and the traction device 400 is wound on the rotation control portion 242.

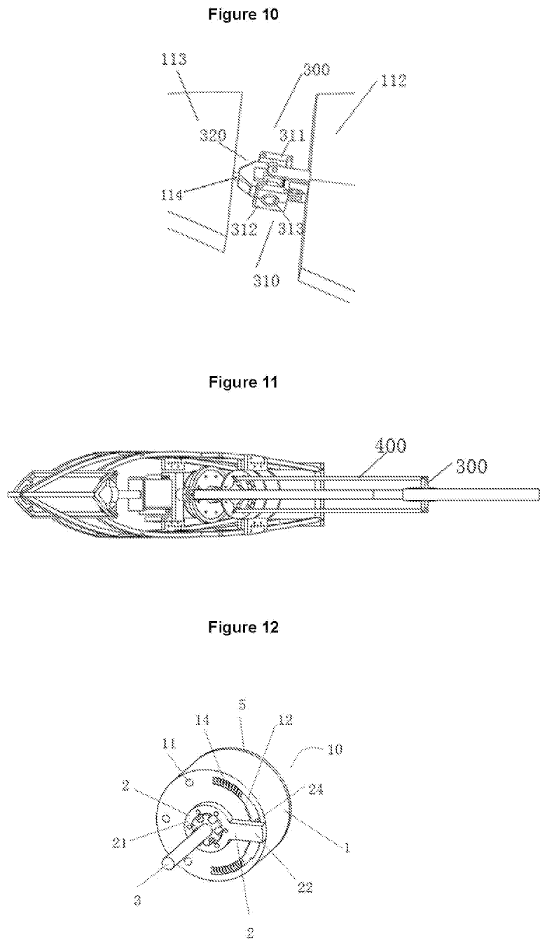

As shown in FIG. 10, FIG. 10 shows a schematic structural diagram of the rotating device 300 in the embodiment of the disclosure and the connection relationship between the rotating device 300 and the wing supporting rod 111 and the wing tip supporting rod 114. The rotating device 300 includes a base portion 310 and a joint portion 320, wherein the base portion 310 is fixedly provided on the second end of the wing supporting rod 111, and the base portion 310 includes two upright posts 311 provided in parallel to each other. A U-shaped supporting table 312 is provided between the upright posts 311, a rotating shaft 313 is provided on the supporting table 312, the upright posts 311 are connected to the middle portion of the rotating shaft 313, and two long sides of the joint portion 320 which is provided in a U shape are rotatably connected to the rotating shaft 313. In this way, the joint portion 320 can swing.

In addition, as mentioned above, the rotating device 300 and the driving unit 200 are also connected BY the traction device 400. As shown in FIG. 9-FIG. 10, one end of the traction device 400 is wound around the driving unit 200, and the other end is wound around the joint portion 320 of the rotating device 300, where the traction device 400 can be, for example, a driving rope for a wing tip rotating joint, and a connecting rod as shown in FIG. 11 of course.

The multi-degree-of-freedom driving device involved in the embodiments of the disclosure can accomplish complex motion based on the change of the wing. In the aircraft with the dual-wing configuration, since the first wing 110 and the second wing 120 are symmetrically provided, the basic motions are the same. Considering that the complex motions are the superposition of basic motions, so only the basic motions of a single wing are introduced here, and these basic motions are independent of each other. The combination of multiple motions can form a complex spatial motion of a single wing, and further the combinations can form a complex motion of double-wing, so as to realize the multi-degree-of-freedom compound movement of the aircraft in the embodiment of the disclosure.

The movement of the first wing 110 is taken as an example as follows, wherein, the driving of the first wing 110 is jointly realized by the four energy storage motor devices, so there are four basic movements for a single wing, which are:

### (1) the Wing Swings Up and Down:

Tant the wing swings up and down here is driven by the first energy storage motor device 210 to generate a reciprocating rotational motion, and the angle of the reciprocating motion is restricted by the length of the sliding chute and the maximum compression limit of the spring provided on the end plane of the front cover of the gland in the first energy storage motor device 210. The crankshaft 250 transmits the reciprocating rotational motion of the first energy storage motor device 210 to the second energy storage motor device 220 to swing up and down, and the second energy storage motor device 220 transmits the reciprocating swing motion to the third energy storage motor device 230 and the wing supporting rod 111 by the supporting portion 270 connected to the third energy storage motor device 230. The supporting rod 111 transmits the up-and-down swing to the fourth energy storage motor device 240, the rotating device 300 and the main body wing plate 112, and the rotating device 300 transmits the up-and-down swing to the wing tip wing plate 113, Thereby, the up-and-down swinging motion of the entire wing is completed.

### (2) Wing Pitching Motion:

Here, the pitching motion of the wing is driven by the third energy storage motor device 230, and the third energy storage motor device 230 transmits the reciprocating rotational motion to the wing supporting rod 111, and the wing supporting rod 111 transmits the pitching motion to the main body wing plate 112, the fourth energy storage motor device 240 and the rotating device 300, and the rotating device 300 transmits the pitching motion to the wing tip wing plate 113 to complete the entire wing pitching motion.

### (3) The Wing Swings Back and Forth:

The back-and-forth swinging of the wing is driven by the second energy storage motor device 220, and the reciprocating angle of the second energy storage motor device 220 is restricted by the length of the sliding chute and the maximum compression limit of the spring provided on the end plane of the front cover of the gland in the second energy storage motor device 220; the second energy storage motor device 220 transmits the back-and-forth swinging to the third energy storage motor device 230 by the coupling, the dial and the supporting portion 270, the third energy storage motor device 230 transmits the back-and-forth swinging motion to the wing supporting rod 111, and the wing supporting rod 111 transmits the back-and-forth swinging motion to the main body wing plate 112, the fourth The energy storage motor device 240 and the rotating device 300, the rotating device 300 transmits the back-and-forth swinging motion to the wing tip supporting rod, and the wing tip supporting rod transmits the f back-and-forth swinging motion to the wing tip wing plate 113 to complete the back-and-forth swinging motion of the entire wing.

### (4) The Wingtip Swings Up and Down:

Here, the up-and-down swinging of the wing tip is independently driven by the fourth energy storage motor device 240, and the fourth energy storage motor device 240 drives the rotation control portion 242 to reciprocate, and the rotation control portion 242 transmits the reciprocating motion by the traction device 400 passing through the second fixing component 241 and the base portion 310 to the joint portion 320, and the reciprocating rotation of the fourth energy storage motor device 240 is changed into the up-and-down swinging motion of the joint portion 320, the joint portion 320 transmits the up-and-down swinging motion to the wing tip supporting rod, and the wing tip supporting rod transmits the up-and-down swinging motion to the wing tip wing plate 113 to complete the up-and-down swinging motion of the entire wing tip.

The single-wing aircraft can show complex wing plane motions based on the combined motion of the above-mentioned four basic motions, which can not only simulate the wing plane motion of creatures, but also greatly improve the propulsion performance of the wings; the superimposed motion forms are more complex and diverse.

In the embodiment of the disclosure, the structure of the motion joints of the wings of the aircraft are compact, and the motion joints are centrally provided on the side of the frame of the aircraft, reducing the mass of the moving portions of the wings and the rotary inertia of the wings, so that the movement of the wings is more flexible; the energy storage braking structure design of the energy storage motor device can make the motor achieve rapid reverse rotation at the limit of the stroke in the reciprocating rotation, to meet the requirements of high frequency reciprocating motion and save energy, so as to meet the requirements of high frequency swinging of the wing. Therefore, the beneficial effect of the embodiment of the disclosure lies in that the embodiment of the disclosure can make the wings of the aircraft achieve different individual actions by providing a plurality of energy storage motor devices, and the combination of multiple individual actions can form complex spatial motions, thereby making the sailing modes of the aircraft more diverse and making the bionic effect better.

The above description is merely a preferred embodiment of the disclosure and an illustration of the technical principles employed. Those skilled in the art should understand that the scope of disclosure involved in the disclosure is not limited to the technical solutions formed by the specific combination of the above-mentioned technical features, and should also covers, without departing from the above-mentioned disclosed concept, the technical solutions formed by the above-mentioned technical features or other technical solutions formed by any combination of equivalent features. For example, a technical solution is formed by replacing the above-mentioned features with the technical features disclosed in the disclosure (but not limited to) with similar functions.

Additionally, although operations are depicted in a particular order, it should not be construed as requiring that the operations be performed in the particular order shown or in a sequential order. Under certain circumstances, multitasking and parallel processing may be advantageous. Likewise, although the above discussion contains several implementation-specific details, it should not be construed as limitations on the scope of the disclosure. Certain features that are described in the context of separate embodiments can also be implemented in combination in a single embodiment. Conversely, various features that are described in the context of a single embodiment can also be implemented in multiple embodiments separately or in any suitable sub-combination.

Although the subject matter has been described in language specific to structural features and/or logical acts of method, it is to be understood that the subject defined in the appended claims is not necessarily limited to the specific features or acts described above. Rather, the specific features and acts described above are merely example forms for implementing the claims.

The various embodiments of the disclosure have been described in detail above, but the disclosure is not limited to these specific embodiments. Those skilled in the art can make various variations and modifications on the basis of the concept of the disclosure. These variations and modifications should fall within the scope of the claimed protection of the disclosure.

What is claimed is:

1. A driving device for an aircraft, which comprises a first energy storage motor device, a second energy storage motor device, a third energy storage motor device, a fourth energy storage motor device and a crankshaft, wherein a first end of the crankshaft is fixedly connected to the first energy storage motor device, and a middle portion of the crankshaft is connected to the second energy storage motor device, the second energy storage motor device is connected by a supporting portion to the third energy storage motor device, and the fourth energy storage motor device is provided at a output end of the third energy storage motor device, power output directions of the first energy storage motor device, the second energy storage motor device, the third energy storage motor and the fourth energy storage motor device are different from each other.

2. The driving device according to claim 1, wherein the supporting portion comprises a base, a circle-shaped portion and a fixing frame, and a fixing column is provided on the base, and the circle-shaped portion is sleeved on the fixing column, and the fixing column is a hollow structure, wherein the fixing frame is provided at a output end of the second energy storage motor device, wherein the base comprises a U-shaped portion and a ring-shaped portion, and the circle-shaped portion and the ring-shaped portion are provided in parallel to each other, the U-shaped portion is connected to the output end of the second energy storage motor device, and the circle-shaped portion and the ring-shaped portion are respectively sleeved at different positions on the third energy storage motor device.

3. The driving device according to claim 1, wherein any one of the first energy storage motor device, the second energy storage motor device, the third energy storage motor device and the fourth energy storage motor device comprises a motor assembly and a coupling, and the motor assembly includes a motor, and a output shaft of the motor is provided on a output side of the motor assembly, wherein a sliding chute is provided on an end plane of the motor assembly and a spring is provided in the sliding chute, one end of the coupling is sleeved on the output shaft and can rotate with the output shaft, and the other end of the coupling moves in the sliding chute and can compress the spring based on the rotation of the output shaft.

4. An aircraft comprising a frame and at least one wing, further comprises the driving device according to any one of claims 1-3.

5. The aircraft according to claim 4, wherein a connecting portion is provided at a second end of the crankshaft, and the first energy storage motor device and the connecting portion are respectively connected to the frame.

6. The aircraft according to claim 5, wherein a first connection component and a second connection component are respectively provided on the frame, and the first connection component is connected to the first energy storage motor device, and the second connection component is connected to the connecting portion.

7. The aircraft according to claim 4, wherein the wing includes a wing supporting rod and a wing tip supporting rod, and a first end of the wing supporting rod is movably connected to the driving device, and a second end of the wing supporting rod is movably connected to the wing tip supporting rod.

8. The aircraft according to claim 7, wherein a rotating device is provided between the wing supporting rod and the wing tip supporting rod.

9. The aircraft according to claim 8, wherein the rotating device comprises a base portion and a joint portion, and the base portion is fixedly provided on the second end of the wing supporting rod, the base portion includes two upright posts provided in parallel with each other, and a U-shaped supporting table is provided between the upright posts and a rotating shaft is provided on the supporting table, the upright posts are connected to a middle portion of the rotating shaft, and two long sides of the joint portion which is provided in a U shape are rotatably connected to the rotating shaft.

10. The aircraft according to claim 8, wherein the driving device and the rotating device are connected by a traction device.

11. The aircraft according to claim 7, wherein the third energy storage motor device is movably connected to the wing supporting rod.

12. The aircraft according to claim 11, wherein the first end of the wing supporting rod is sleeved on the coupling of the output end of the third energy storage motor device, and the wing supporting rod and the supporting portion are connected by a first fixing component.

13. The aircraft according to claim 7, wherein a main body wing plate and a wing tip wing plate are respectively laid on the wing supporting rod and the wing tip supporting rod.

14. The aircraft according to claim 7, wherein the fourth energy storage motor device is provided on the wing supporting rod.

15. The aircraft according to claim 14, wherein one end of the fourth energy storage motor device is fixedly connected to the coupling of the output end of the third energy storage motor device, and the other end is connected to the wing supporting rod by a second fixing component.

16. The aircraft according to claim 10, wherein a rotation control portion is provided on the coupling of an output end of the fourth energy storage motor device, and the rotation control portion is connected to the rotating device by the traction device.
